(19) United States
(12) Patent Application Publication
(10) Pub. No.: US 2007/0089461 A1
(43) Pub. Date: Apr. 26, 2007

(54) Method of producing porous glass preform for optical fiber

(75) Inventors: Syuhei Hayami, Tokyo (JP); Kiyoshi Arima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 11/544,555

(22) Filed: Oct. 10, 2006

(30) Foreign Application Priority Data
Oct. 11, 2005 (JP) 2005-296811

(51) Int. Cl. C03B 37/07; C03B 37/018; G01N 21/00

(52) U.S. Cl. 65/377; 65/421

(57) ABSTRACT

A method of producing a porous glass preform for an optical fiber includes supplying glass material gas and combustion gas to a burner for synthesizing glass particles to produce glass particles, while relatively reciprocating the burner and a target rod that is rotating; and depositing the glass particles around the target rod. Density of the glass particles deposited per unit time ρ_{c} [g/cm³] is calculated. A sweeping speed of the burner S [mm/sec] is controlled to be decreased when the density ρ_{c} [g/cm³] is smaller than a target density ρ [g/cm³] and to be increased when the density ρ_{c} [g/cm³] is larger than the target density ρ [g/cm³].

### BACKGROUND OF THE INVENTION

1. Field of the Invention

The present invention relates to a method of producing a porous glass preform for an optical fiber.

2. Description of the Related Art

Recently, a size of a preform for an optical fiber is getting larger to improve productivity of the preform. The preform for the optical fiber is produced by applying a cladding portion to a target rod by an outside vapor phase deposition (OVD) method or a rod in tube (ROD) method. The target rod includes a core that propagates a light, which is produced by a known method such as a vapor phase axial deposition (VAD) method, a modified chemical vapor deposition (MCVD) method, and a plasma deposition method. When the OVD is used to produce the cladding portion, the size of the optical fiber preform can be increased in length and in diameter. However, the increase in length requires large production equipment that can be restricted by a space and cost for facility, and the resulting preform is difficult to handle. It is therefore preferable to increase the size of the optical fiber preform in diameter to a maximum extent. In addition, because there is a natural limit to the diameter of a porous preform for optical fiber produced by the OVD method due to the restriction by the size of the existing facility, there is a demand for increasing density of glass particle deposition to increase the size of the optical fiber preform while taking into account the restriction.

In general, when the glass particles are deposited around the target rod by the OVD, the density of the glass particle deposition decreases as the layer of the glass particle deposition becomes thicker, i.e., as getting closer to the final outer diameter of the preform. To prevent the decrease of the density, an amount of combustion gas of oxygen and hydrogen supplied to a burner has been increased.

However, when the supplied combustion gas exceeds a certain amount, a flame becomes unstable, causing such problems as a rough surface of the glass particle deposition and deteriorated efficiency of the glass particle deposition. To solve the problems, a method of controlling temperature of the surface of the glass particle deposition by controlling rotation speed has been proposed. In other words, the efficiency and the density of the glass particle deposition is retained by gradually reducing the rotation speed as the thickness of the deposition layer increases so that the surface is exposed to the flame for a longer time to reach a desired temperature (see, for example, Japanese Patent Laid-open No. H2-307837).

However, as the size of the preform further increases, there is a need to extremely reduce the rotation speed to control the density by the rotation speed alone, which results in a problem that operation of a rotating mechanism becomes not stable enough to take control.

### SUMMARY OF THE INVENTION

It is an object of the present invention to at least partially solve the problems in the conventional technology.

A method of producing a porous glass preform for an optical fiber, according to one aspect of the present invention, includes supplying glass material gas and combustion gas to a burner for synthesizing glass particles to produce glass particles, while relatively reciprocating the burner and a target rod that is rotating; and depositing the glass particles around the target rod. Density of the glass particles deposited per unit time ρ_{c} [g/cm³] is calculated. A sweeping speed of the burner S [mm/sec] is controlled to be decreased when the density ρ_{c} [g/cm³] is smaller than a target density ρ [g/cm³] and to be increased when the density ρ_{c} [g/cm³] is larger than the target density ρ [g/cm³].

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of significant units in production equipment used to produce a porous glass preform for an optical fiber according to an embodiment of the present invention;

FIG. 2 is a graph indicating that density of glass particle deposition acquired in an experiment is proportional to a product of 1/S and 1/R;

FIG. 3 is a graph indicating relations among rotation speed of a target rod, speed of a burner, and the density, of the glass particle deposition when trying to increase the density of the glass particle deposition by controlling the rotation speed of the target rod alone to increase temperature of a surface of the glass particle deposition; and

FIG. 4 is a graph indicating relations among the rotation speed of the target rod, the speed of the burner, and the density of the glass particle deposition when trying to reduce the rotation speed and the speed of the burner to increase the density of the glass particle deposition without extremely reducing the rotation speed.

### DETAILED DESCRIPTION OF THE PREFERRED EMBODIMENTS

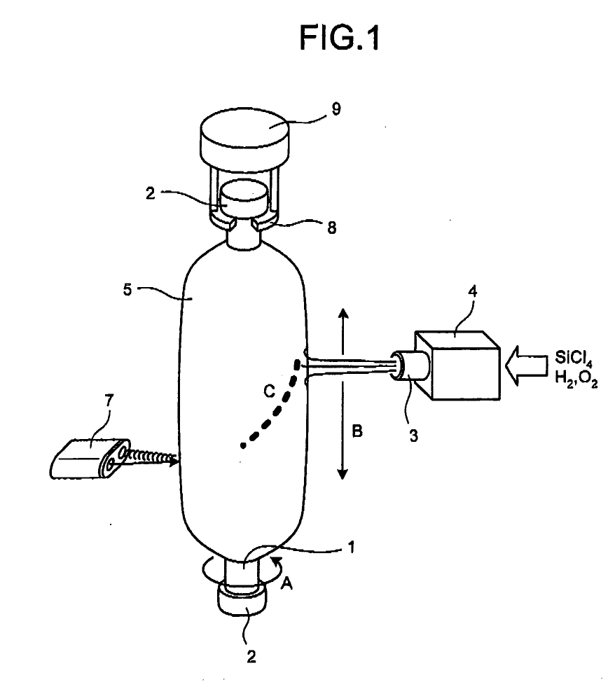

Exemplary embodiments of a method of producing a porous glass preform for an optical fiber according to the present invention are explained below in detail with reference to FIGS. 1 to 4. The present invention is not limited to the embodiments explained below, and can be modified in various ways within the scope of the invention.

FIG. 1 is a perspective view of significant units in production equipment used to produce a porous glass preform for an optical fiber according to an embodiment of the present invention. The embodiment is based on a so-called outside vapor phase deposition (OVD) method. Both ends of a target rod 1 are axially supported by supporting units 2. A driving mechanism (not shown) is controlled by a controlling unit (not shown) to rotate the target rod 1 in a predetermined direction indicated by an arrow A at a predetermined speed. Moreover, in such a state, the driving mechanism linearly reciprocates a burner 4 for synthesizing glass particles in an axial direction of the target rod 1 as indicated by an arrow B.

The burner 4 for synthesizing glass particles is supplied with SiCl₄ gas that is glass material gas as well as H₂ gas and O₂ gas that is combustion gas to synthesize glass particles by flame hydrolyzing the glass material gas in a flame produced by the combustion gas. The glass particles are sprayed from a flame sprayer 3 onto a periphery of the rotating target rod 1 to deposit glass particles thereon, and thereby a porous glass preform 5 for an optical fiber is produced. The target rod 1 is generally a vitrified core rod applied with a part of cladding.

The axial motion of the burner 4 for synthesizing glass particles has to be so only relatively to the rotating target rod 1. While the burner 4 is linearly reciprocated against the target rod 1 according to the embodiment, the burner 4 can be fixed and the target rod 1 can be linearly reciprocated in parallel with the rotation axis.

A top end of the target rod 1 is rotatably hung by a chuck 8 extending from a weight meter 9. The weight meter 9 measures weight of the glass particles deposited on the periphery of the target rod 1. An outer-diameter gauge 7 is provided lateral to the target rod 1 at a predetermined distance. The outer-diameter gauge 7 measures an outer diameter of the glass particle deposition based on time of an emitted laser beam being reflected by a surface of the glass particle deposition and returning to the outer-diameter gauge 7.

In a general method of forming the glass particle deposition, in a single step, i.e., while a single porous glass preform 5 is being produced, a relative moving speed between the target rod 1 and the burner 4 for synthesizing glass particles and a rotation speed of the target rod 1 are constant.

The inventors confirmed from a detailed experiment that density of the glass particle deposition is increased by reducing the relative moving speed to the burner 4 for synthesizing glass particles even when the rotation speed remains same. The inventors also found that, regardless of the same rotation speed and the same relative moving speed, the density of the glass particle deposition varies when the outer diameter of the glass particle deposition varies.

Moreover, the inventors found that the density of the glass particles deposited under a certain gas condition is inversely proportional to a sweeping speed of the burner 4 S and the outer diameter of the glass particle deposition R. In other words, the density of the glass particle deposition is proportional to a product of 1/S and 1/R. The sweeping speed of the burner 4 S [mm/sec] can be calculated from the outer diameter of the glass particle deposition R [millimeters], the rotation speed of the target rod 1 r [rpm], and the relative moving speed between the target rod 1 and the burner 4 V [mm/sec] using following Equation, and traces a dotted line C shown in FIG. 1.
S={square root over (((πRr)²+V²))} [mm/sec]

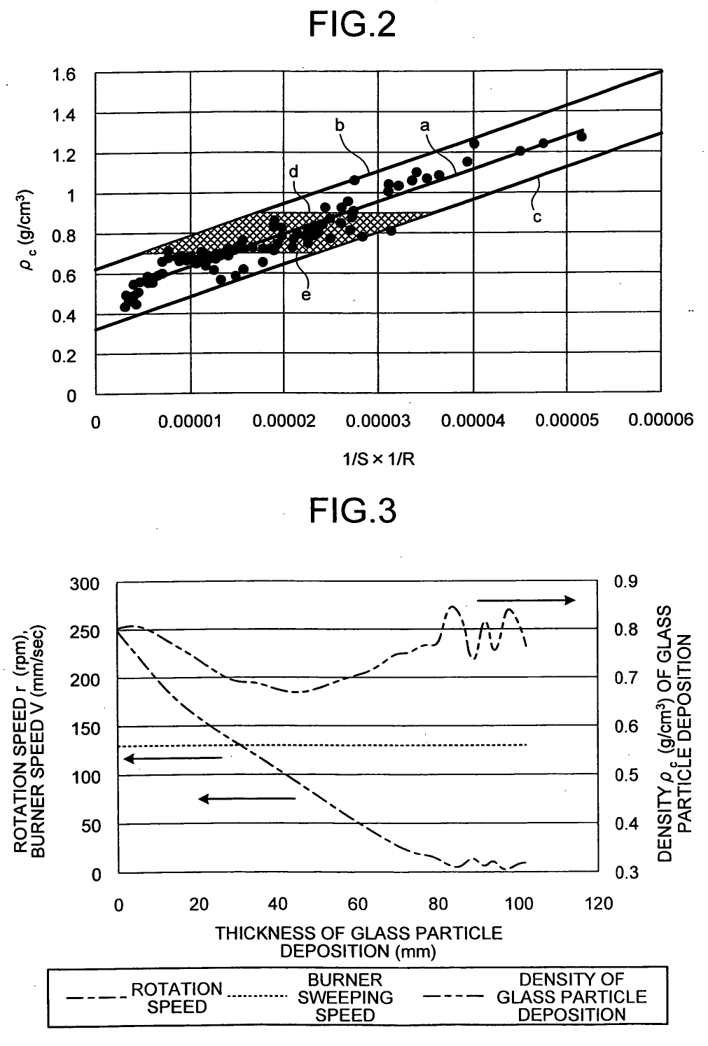

FIG. 2 is a graph of the density data of the glass particle deposition acquired through the experiment plotted by arranging the product of 1/S and 1/R on a horizontal axis. In the experiment, 80 g/min of the SiCl₄ gas is supplied as the glass material gas, 240 SLM of the H₂ gas and 120 SLM of the O₂ gas is supplied as the combustion gas, which is the gas condition in the experiment. The distance from the flame sprayer 3 of the burner 4 for synthesizing glass particles to the surface of the glass particle deposition is fixed to 150 millimeters.

In FIG. 2, the product of 1/S and 1/R is indicated on the horizontal axis, and a density of the glass particles deposited per unit time ρ_{c} [g/cm³] is indicated on the vertical axis. The density of the glass particles deposited per unit time is distributed along a positive slope (line “a ” in FIG. 2). In other words, the density is proportional to the product of 1/S and 1/R. The inventors found that the glass particle deposition could be easily formed with a desired density distribution by changing the sweeping speed of the burner 4 according to the outer diameter of the glass particle deposition based on a relational expression that represents the line.

Further experiment shows that, when the glass particles are deposited under the condition that the density of the glass particles deposited per unit time ρ_{c} targeting a density ρ is more than ρ+0.15 (line “b ” in FIG. 2), the temperature of the deposition surface increases and a portion of the glass particles is sintered, resulting in appearance defect due to a bump nucleating the sintered portion. The experiment also shows that the deposition under the condition that the density of the glass particles deposited per unit time ρ_{c} is less than ρ−0.15 (line “c” in FIG. 2) causes the cracks more frequently and is not desirable to increase the size of the preform, because the outer diameter of the glass particle deposition grows too much. As a result, it is preferable to control the sweeping speed of the burner 4 so as to satisfy the following equation:
ρ−0.15≦ρ_{c}≦ρ+0.15 [g/cm³]

As described above, the density of the glass particle deposition generally decreases toward the target outer diameter of the preform. Decrease of the density needs to be prevented in the production of the preform. In this regard, the inventors found that, assuming that the outer diameter of the glass particle deposition when the deposition is completed, namely an outer diameter of the preform, is L [millimeters], to produce a portion of the glass particle deposition with the outer diameter equal to or more than 0.8 L millimeters and equal to or less than L millimeters, a desirable preform is produced by making the density of the glass particles deposited per unit time ρ_{c} equal to or more than 0.7 g/cm³ and equal to or less than 0.9 g/cm³. By increasing the density of the glass particles deposited per unit time ρ_{c}, the size of the preform can be increased without increasing the final outer diameter L of the preform; however, dehydration of the glass particle deposition becomes more difficult as the density of the glass particles deposited per unit time ρ_{c} increases. As a result, the density ρ_{c} is limited to a predetermined threshold.

As a result of the experiment, unless the density is less than 0.9 g/cm³ (line “d ” in FIG. 2) when the outer diameter of the glass particle deposition R is equal to or more than 0.8 L millimeters and equal to or less than L millimeters, the glass particle deposition cannot be sufficiently dehydrated in a vitrification process that follows, and transmission loss increases at a 1380-nanometer wavelength of the optical fiber produced using the preform. Moreover, if the density is less than 0.7 g/cm³ (line “e ” in FIG. 2) when the outer diameter of the glass particle deposition R is equal to or more than 0.8 L millimeters and equal to or less than L millimeters, the final outer diameter L increases, which is not beneficial to increasing the size of the preform.

From the equations acquired from FIG. 2, the inventors confirmed that the size of the preform can be increased by controlling the sweeping speed so that the density of the glass particles deposited per unit time ρ_{c} is equal to or more than 0.7 g/cm³ and equal to or less than 0.9 g/cm³ when the outer diameter of the glass particle deposition R is equal to or more than 0.8 L millimeters and equal to or less than L millimeters (within an area surrounded by the lines “b”, “c”, “d”, and “e ” in FIG. 2).

As a comparative example, the inventors tried to increase the density ρ_{c} by controlling the rotation speed of the target rod r alone to increase the temperature of the surface of the glass particle deposition. The burner speed V is constant in the experiment. Using a target rod with a 40-millimeter outer diameter and at the burner speed V of 130 mm/sec, a glass particle deposition, i.e., a porous glass preform, with approximately 250 millimeters of the final outer diameter L was synthesized. FIG. 3 is a graph of relations among the rotation speed of the target rod, the burner speed, and the density of the glass particle deposition. In FIG. 3, the vertical axis indicates the thickness of the glass particle deposition in millimeter, and the horizontal axis indicates the rotation speed r in rpm, the burner speed V in mm/sec, and the density of the glass particle deposition ρ_{c} in g/cm³.

The density ρ_{c} of the glass particle deposition was controlled to a certain degree; however, the rotation speed r needs to be extremely low to make the density ρ_{c} equal to or less than 0.7 when the outer diameter of the glass particle deposition R is equal to or more than 0.8 L and equal to or less than L. As a result, rotation of the rotation mechanism is unstable and difficult to control. As seen in FIG. 3, when the rotation speed is closer to zero and cannot be finely controlled, deviation of the rotation speed increases, and accordingly, the density of the glass particles deposited per unit time ρ_{c} [g/cm3] greatly fluctuates. The glass preform produced in this manner is not desirable because it can be not sufficiently dehydrated in the vitrification process due to an abrupt change of the density distribution in the radial direction.

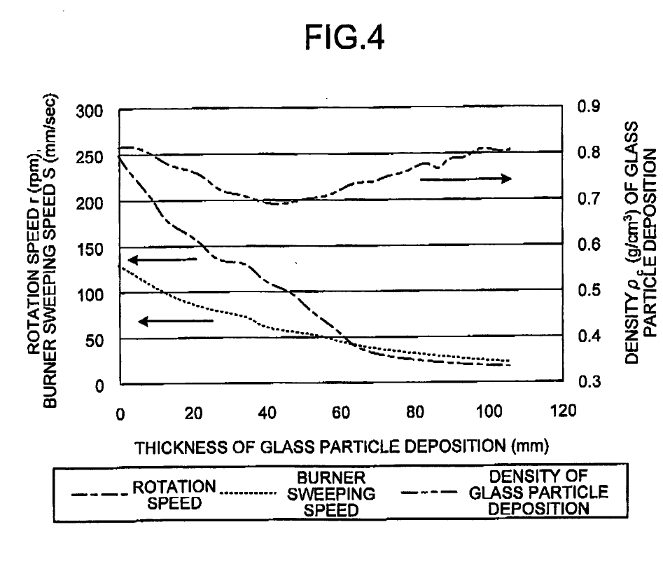

As a first example, the inventors tried to reduce the burner speed V as well as the rotation speed, to increase the density of the glass particle deposition ρ_{c} without extremely reducing the rotation speed r. The outer diameter of the target rod was 40 millimeters as in the comparative example, and a porous glass preform with approximately 250 millimeters of the final outer diameter L was synthesized. FIG. 4 is a graph of relations among the rotation speed of the target rod, the burner speed, and the density of the glass particle deposition in the experiment. Each of the vertical axis and the horizontal axis indicates the same items as in FIG. 3.

By reducing the burner speed V, the rotation speed r remained within a finely controllable range, and the glass particles were deposited with the desired density. By using the method explained in the embodiment above, the density ρ_{c} can be equal to or less than 0.7 when the outer diameter of the glass particle deposition R is equal to or more than 0.8 L and equal to or less than L.

As a second example, the inventors compared data of the thickness and the density of the glass particle deposition recorded in a recording unit with relation between the target thickness and the target density of the glass particle deposition, and tried to deposit the glass particles on the next rod by decreasing the sweeping speed S at a portion where the density of the glass particle deposition was lower than the target density of the glass particle deposition and increasing the sweeping speed S at a portion where the density of the glass particle deposition was higher than the target density of the glass particle deposition. As a result, the data of the thickness and the density of the glass particle deposition recorded in the recording unit when the rod was produced well matched the relation between the target thickness and the target density of the glass particle deposition. The data of the thickness and the density of the glass particle deposition in the experiment substantially match the data shown in FIG. 4.

According to the embodiment, the distance between the surface of the glass particle deposition and the flame sprayer 3 of the burner 4 is controlled to remain constant under a predetermined optimal condition so that the glass particles are finely deposited. To control the distance in this manner is an easy and very effective method for depositing the glass particles using the flame of the burner 4 constantly under the optimal condition. However, controlling the distance between the surface of the glass particle deposition and the flame sprayer 3 of the burner 4 to be constant is not an essential condition. The inventors confirmed that the density of the glass particle deposition is proportional to the product of 1/S and 1/R even when the control is not performed in this manner.

Furthermore, even if the type of the burner such as the method, the shape, and the size and the gas condition such as the element of the glass material gas, the element of the combustion gas, flow rate of each gas, and proportion of both gases are different from those according to the embodiment, the density of the glass particle deposition is proportional to the product of 1/S and 1/R under a predetermined condition.

As described above, because the target density distribution of the glass particle deposition can be finely controlled, the method of producing the porous glass preform for the optical fiber according to an aspect of the present invention is useful for forming the glass particle deposition by the OVD, and especially advantageous to increase the size of the preform for the optical fiber.

Further effects and modifications can be readily thought of by those skilled in the art. A broader aspect of the present invention is not limited to the specific details and the typical embodiment described above. The present invention can be modified without departing from the spirit or scope of the present invention as defined by accompanying claims and equivalents thereof.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1-10. (canceled)

11. A method of producing a porous glass preform for an optical fiber, the method comprising;
supplying glass material gas and combustion gas to a burner for synthesizing glass particles to produce glass particles, while relatively reciprocating the burner and a target rod that is rotating;
depositing the glass particles around the target rod;
calculating density of the glass particles deposited per unit time; and
controlling a sweeping speed of the burner including
decreasing the sweeping speed of the burner when calculated density is smaller than a predetermined target density; and
increasing the sweeping speed of the burner when the calculated density is larger than the target density.

12. The method according to claim 11, wherein
the sweeping speed of the burner is calculated by
ρ=aX+b, and
X=1/S×1/R
where ρ is the target density, S is the sweeping speed of the burner, R is an outer diameter of the glass particle deposition, and a and b are arbitrary constants.

13. The method according to claim 11, wherein
the sweeping speed of the burner is controlled in such a manner that the density of the glass particles deposited per unit time is in a range
ρ−0.15≦ρ_{c}≦ρ+0.15
where ρ is the target density, and ρ_{c} is the density of the glass particles deposited per unit time.

14. The method according to claim 11, wherein
when producing the glass particle deposition satisfying
0.8L≦R≦L
where L is a final diameter of the porous glass preform to be produced, and R is an outer diameter of the porous glass preform under production, the sweeping speed of the burner is controlled in such a manner that the density of the glass particles deposited per unit time is in a range
0.7≦ρ_{c}≦0.9
where ρ_{c} is the density of the glass particles.

15. The method according to claim 11, wherein
the sweeping speed of the burner is changed by changing rotation speed of the target rod and relative moving speed between the burner and the target rod along a rotation axis of the burner.

16. A method of producing a porous glass preform for an optical fiber, the method comprising:
supplying glass material gas and combustion gas to a burner for synthesizing glass particles to produce glass particles, while relatively reciprocating the burner and a target rod that is rotating;
depositing the glass particles around the target rod;
calculating density of the glass particles deposited per unit time;
producing the glass preform for the optical fiber, while sequentially recording calculated density, and
producing next rod by controlling a sweeping speed of the burner, wherein
the sweeping speed of the burner is decreased when depositing an area where recorded density is smaller than a target density, and increased when depositing an area where the recorded density is larger than the target density.

17. The method according to claim 16, wherein
the sweeping speed of the burner is calculated by
ρ=aX+b, and
X=1/S×1/R
where ρ is the target density, S is the sweeping speed of the burner, R is an outer diameter of the glass particle deposition, and a and b are arbitrary constants.

18. The method according to claim 16, wherein
the sweeping speed of the burner, is controlled in such a manner that the density of the glass particles deposited per unit time is in a range
ρ−0.15≦ρ_{c}≦ρ+0.15
where ρ is the target density, and ρ_{c} is the density of the glass particles deposited per unit time.

19. The method according to claim 16, wherein
when producing the glass particle deposition satisfying
0.8L≦R≦L
where L is a final diameter of the porous glass preform to be produced, and R is an outer diameter of the porous glass preform under production, the sweeping speed of the burner is controlled in such a manner that the density of the glass particles deposited per unit time is in a range
0.7≦ρ_{c}≦0.9
where ρ_{c} is the density of the glass particles.

20. The method according to claim 16, wherein
the sweeping speed of the burner is changed by changing rotation speed of the target rod and relative moving speed between the burner and the target rod along a rotation axis of the burner.
